(19) United States
(12) Patent Application Publication
(10) Pub. No.: US 2022/0304243 A1
(43) Pub. Date: Sep. 29, 2022

(54) TRIMMER HEIGHT ADJUSTMENT MECHANISM

(71) Applicant: BRYAN DAVID STORK, FORT MYERS, FL (US)

(72) Inventor: BRYAN DAVID STORK, FORT MYERS, FL (US)

(21) Appl. No.: 17/212,673

(22) Filed: Mar. 25, 2021

(51) Int. Cl. A01G 3/04

(52) U.S. Cl. CPC A01G 3/0417; A01G 2003/0443

(57) ABSTRACT

A trimmer height adjustment mechanism (103) having a forward guard (105a); a forward spacer (112b); and an arm (109). Such trimmer height adjustment mechanism allows a string trimmer user to: (a) achieve a uniform, user-selected cutting height for groundcover; and (b) readily engage/disengage the height adjustment mechanism so that the user can change between a uniform height setting (e.g., while cutting even terrain) and an ordinary string trimmer operation (i.e., when a user is not concerned about the height of the groundcover being cut or wishes to cut as short a height as possible, e.g., while cutting grass around the base of a tree).

### FIELD OF THE INVENTION

This invention relates to grass and vegetation string trimmers and more particularly to a string trimmer having a trimming height adjustment mechanism.

### BACKGROUND OF THE INVENTION

A string trimmer commonly called a weed eater, weed whacker, or brush cutter) is a type of garden tool for cutting grass, small weeds, and other groundcover. String trimmers generally use a rotating monofilament line (i.e., a “string”) in lieu of a blade to cut groundcover. Such trimmers have a semi-circular guard near the rear of the trimmer, with such guard helping prevent debris from ricocheting upward towards the person using the trimmer.

Historically, string trimmers did not have a means by which the cutting height of the string was adjustable relative to the ground in order that the groundcover could be cut at a uniform height. More recently, various attempts have been made to address this issue.

One such attempt is disclosed in U.S. Pat. No. 3,193,996 (Wellborn) which teaches a combination lawn edger and trimmer, the cutting height of which can be adjusted by a wheel bracket more akin to a lawn mower.

Another such attempt is disclosed in U.S. Pat. No. 4,531,350 (Huthmacher) which teaches a wheeled assembly that converts a hand-held power grass trimmer into a mower and is adjustable to cut grass at a uniform height.

Another such attempt is disclosed in U.S. Pat. No. 4,879,869 (Buckendorf, Jr.) which teaches a wheeled attachment for a hand-held grass trimmer whereby the wheels can be swiveled to adjust the height of the grass cut.

Another such attempt is disclosed in U.S. Pat. No. 5,577,374 (Huston) which teaches a wheel mounted grass trimmer in which the height of the wheels can be adjusted, thereby adjusting the height of the grass cut.

Another such attempt is disclosed in U.S. Pat. No. 5,906,051 (Nannen) which teaches a height adjustable grass trimmer that uses a bump-feed mechanism to adjust trimming height.

Another such attempt is disclosed in U.S. Pat. No. 5,970,694 (Knox, Jr.) which teaches a retractable three-wheeled stabilizer that attaches to a grass trimmer that can be used to adjust grass cutting height.

Another such attempt is disclosed in U.S. Pat. Nos. 6,052,974 and 6,298,642 (Harb) which teach adjustable height cutting heads for a grass trimmer comprising a central cylinder to which the string cutter can be attached at desired heights.

Another such attempt is disclosed in U.S. Pat. No. 6,971,223 (Scott et al.) which teaches a wheeled trimmer which provides for adjustable cutting height using a central shaft having selective locking levels for the cutting head.

Another such attempt is disclosed in U.S. Pat. No. 7,302,790 (Brandon) which teaches a grass trimmer by which the height of the spindle is adjustable by use of a keyed spindle shaft.

Another such attempt is disclosed in U.S. Pat. No. 8,186,135 (Leonardi et al.) which teaches an electrically-powered combination lawn mower, trimmer and edger that could be adjustable in height by the wheels.

### SUMMARY OF THE INVENTION

The primary object of the present invention is directed to a trimmer height adjustment mechanism.

Another object of the present invention is to allow a string trimmer user to: (a) achieve a uniform, user-selected cutting height for groundcover; and (b) readily engage/disengage the height adjustment mechanism so that the user can change between a uniform height setting (e.g., while cutting even terrain) and an ordinary string trimmer operation (i.e., when a user is not concerned about the height of the groundcover being cut or wishes to cut as short a height as possible, e.g., while cutting grass around the base of a tree).

An additional object of the present invention is to provide a device that could be retrofitted on to existing string trimmers in order to save costs.

The present invention fulfills the above and other objects by providing a trimmer height adjustment mechanism having three major components, namely: (i) forward and aft guards; (ii) forward and aft spacers; and (iii) a locking, pivot arm. The forward guard is attached to the pivot arm which, in turn, is attached to the trimmer and held in place on the trimmer with a trimmer mount, while the aft guard is directly attached to the trimmer. The forward and aft spacers are each attached to the forward and aft guards, respectively.

A string trimmer user is able to adjust the relative cutting height of the trimmer by vertically adjusting the position of the forward and aft spacers relative to the forward and aft guards. By doing so, the user is able to adjust the relative height between the trimmer head (i.e., the cutting height) and the ground. In one embodiment, easy-to-use wingnuts are used as fasteners to affix the spacers to the guards—allowing the user to quickly adjust the relative cutting height.

The locking, pivot arm allows the forward guard to readily engage and disengage depending on whether the user wishes to maintain a uniform cutting height. For example, a user may want a uniform cutting height while cutting grass in the middle of a lawn, but may want to disengage the trimmer height adjustment mechanism when cutting grass near a large rock or near the base of a tree. In the preferred embodiment, the locking pivot arm rotates about an axis perpendicular to the trimmer, i.e., the locking pivot arm rotates in a vertical direction relative to the trimmer (in other words, the pivot arm is swiveled backwards). In one embodiment, a hand-operated lever is attached to a connector which, in turn, is attached to the locking pivot arm. In this embodiment, the trimmer height adjustment mechanism can be readily engaged or disengaged by automatically pulling back on the lever; thereby swiveling the pivot arm from an engaged to a disengaged position. In another embodiment, the locking pivot arm rotates about an axis parallel to the trimmer, i.e., the locking pivot arm rotates in a horizontal direction relative to the trimmer (in other words, the pivot arm is swung to one side).

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1A is a top perspective view of a Trimmer with a Trimmer Height Adjustment Mechanism in an engaged position.

FIG. 1B is a bottom perspective view of a Trimmer with a Trimmer Height Adjustment Mechanism in an engaged position.

FIG. 2A is a side view of a Trimmer Height Adjustment Mechanism.

FIG. 2B is an enlarged side view of a Trimmer Height Adjustment Mechanism showing a Locking Pivot Assembly.

FIG. 3A is a top perspective view of a Trimmer with a Trimmer Height Adjustment Mechanism in a disengaged position.

FIG. 3A is an enlarged top perspective view of a Trimmer with a Trimmer Height Adjustment Mechanism in a disengaged position.

FIG. 4 is an exploded view of a Forward Guard and Forward Spacer assembly of a Trimmer Height Adjustment Mechanism.

FIG. 5A is a front perspective view of a Trimmer Height Adjustment Mechanism in an engaged position with a Forward Spacer at a relative height of h₁.

FIG. 5B is a front perspective view of a Trimmer Height Adjustment Mechanism in an engaged position with a Forward Spacer at a relative height of h₂.

### REFERENCE NUMERAL CHART

For purposes of describing the preferred embodiment, the terminology used in reference to the number components in the drawings is as follows:

| | |
|---|---|
| 100 | Trimmer |
| 101 | Trimmer Head |
| 103 | Trimmer Height |
| | Adjustment Mechanism |
| 105a | Forward Guard |
| 05b | Aft Guard |
| 107 | Bracket |
| 109 | Arm |
| 111 | Locking Pivot Assembly |
| 111a | Trimmer Mount |
| 111b | Pivot Hole |
| 111c | Pivot Pin (e.g., rivet) |
| 111d | First Arm Hole |
| 111e | Second Arm Hole |
| 111f | Surface |
| 111g | Surface Hole |
| 111h | Locking Fastener |
| 112a | Forward Spacer |
| 112b | Aft Spacer |
| 113 | Slot |
| 115 | Fastener |
| 115a | Wingnut |
| 115b | Washer |
| 115c | Bolt |
| 117 | Fastener Base |

### DETAILED DESCRIPTION OF THE INVENTION

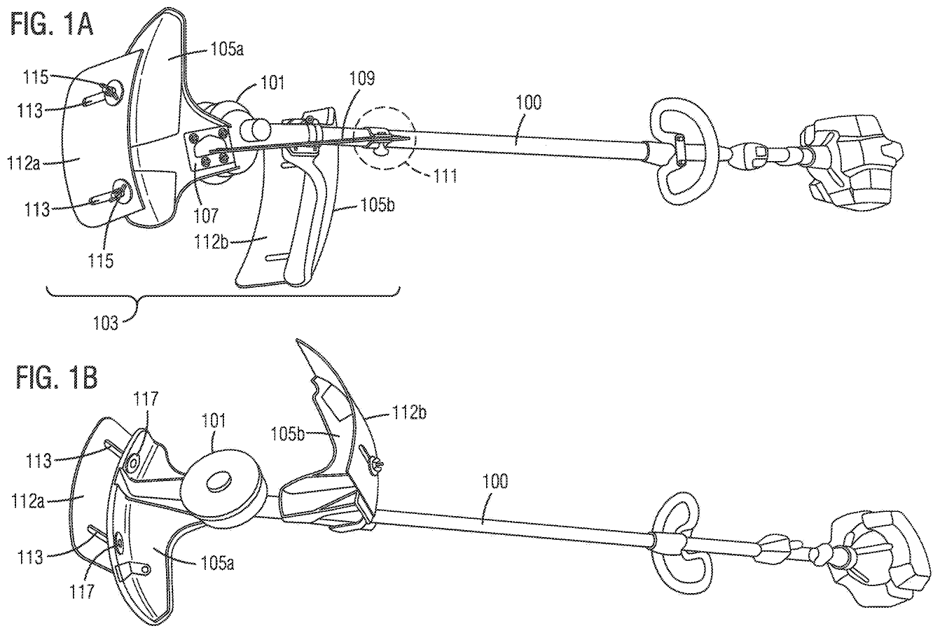

The instant invention is directed towards a Trimmer Height Adjustment Mechanism. FIG. 1A depicts a Trimmer 100 with a Trimmer Height Adjustment Mechanism 103 detachably affixed thereto. The Trimmer Height Adjustment Mechanism 103 comprises a Forward Guard 105A and an Aft Guard 105B. The Forward Guard 105A has a Forward Spacer 112A detachably affixed thereto. The Forward Spacer 112A is detachably affixed to the Forward Guard 105A by means of at least one Slot 113 and at least one Fastener 115. The Forward Guard 105A is connected to an Arm 109 using a Bracket 107. The Arm 109 is connected to the Trimmer 100 by a Locking Pivot Assembly 111. The Aft Guard 105B similarly has an Aft Spacer 112B detachably affixed thereto. The Aft Spacer 112B is affixed to the Aft Guard 105B by a Slot 113 and a Fastener 115 which allows the Aft Spacer 112B to slide upwards and downwards relative to the Aft Guard 105B. The Forward Guard 105 and the Aft Guard 105B are spaced such that the Trimmer Head 101 is allowed to freely rotate with a monofilament line when such line is at its maximum length. FIG. 1A further shows the Trimmer Height Adjustment Mechanism 103 in an engaged position.

FIG. 1B depicts an underside of the Trimmer 100. The Forward Guard 105A is detachably affixed to the Trimmer 100. As can be clearly seen in FIG. 1B, the Trimmer Head 101 and the line protruding therefrom extends to cover the area encompassed by the semicircular Forward Spacer 112A and the Aft Spacer 112B which are connected to the Forward Guard 105A and Aft Guard 105B members respectively.

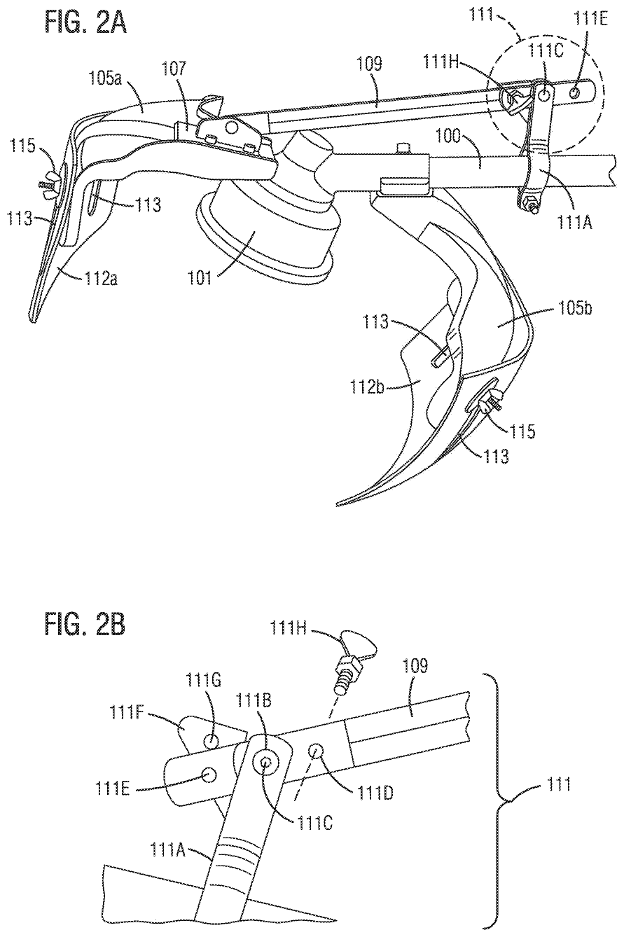

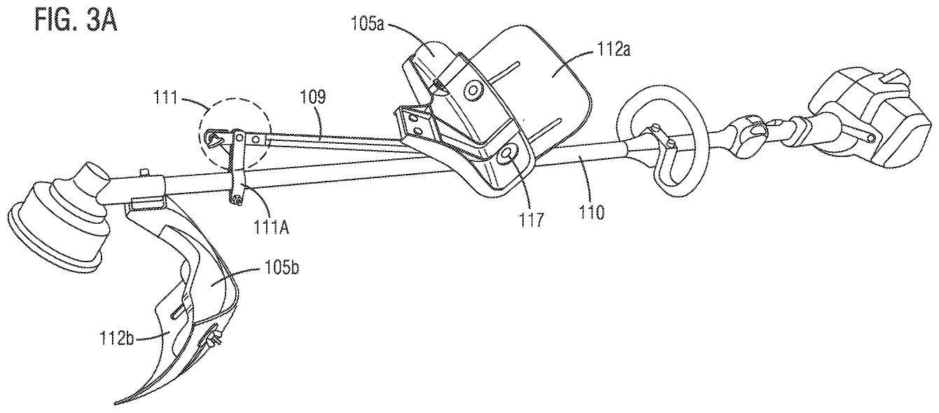

FIG. 2A depicts a close-up of the Trimmer Height Adjustment Mechanism 103. As can be seen in FIG. 2A, the Forward Guard 105A is connected to the Trimmer 100. The Forward Guard 105A is detachably connected to the Forward Spacer 112A by a Fastener 115. As can be seen in FIG. 2A, the Fastener 115 may be a Wingnut and bolt assembly. The Forward Guard 105A is connected to the Arm 109 by a Bracket 107. The Arm 109 has two distal ends, with a first end being affixed to the Forward Guard 105A in the Bracket 107. The second distal end of the Arm 109 further comprises a Locking Pivot Assembly 111. The Locking Pivot Assembly 111 further comprises a Trimmer Mount 111a which connects the Arm 109 and the Locking Pivot Assembly 111 to the Trimmer 100. The Locking Pivot Assembly 111 further comprises a Pivot Pin 111C. As can be seen in FIG. 2A, the Pivot Pin 111C may take the form of a rivet. The Locking Pivot Assembly 111 further comprises a First Arm Hole 111D (not shown) through which a Locking Fastener 111H is detachably affixed, thereby locking the Arm 109 in the engaged position. The Locking Pivot Assembly 111 further comprises a Second Arm Hole 111E. FIG. 2A further depicts an Aft Guard 105B having an Aft Spacer 112B detachably affixed thereto by a Fastener 115.

FIG. 2B shows an enlarged view of the Locking Pivot Assembly 111. As shown in FIG. 2B, a Trimmer Mount 111A connects the Locking Pivot Assembly 111 to the Trimmer 100. The Arm 109 has a First Arm Hole 111D, a Pivot Hole 111B, and a Second Arm Hole 111E. The Pivot Hole 111B is dimensionally-sized to accommodate a Pivot Pin 111C which is placed through the Trimmer Mount 111A, and the Arm 109 to pivotally mount the Arm 109 to the Trimmer Mount 111A. Surface 111F is connected to the Trimmer Mount 111A. A Surface Hole 111G is formed in the Surface 111F. The First Arm Hole 111D and the Second Arm Hole 111E are located equidistant about an axis defined by the Pivot Pin 111C and the Pivot Hole 111B. The Surface Hole 111G is similarly located at a point equidistant from the Pivot Hole 111B albeit on the Surface 111F and not on the Arm 109. This creates an alignment whereby, as the Arm 109 is rotated about the Pivot Pin 111C's axis, the First Arm Hole 111D will initially align with the Surface Hole 111G when the Trimmer Height Adjustment Mechanism 103 is in the engaged position. As the Arm 109 is rotated about the Pivot Pin 111C's axis, the Surface Hole 111G aligns with the Second Arm Hole 111E when the Trimmer Height Adjustment Mechanism 103 is in the disengaged position. Thus, the Arm 109 may be locked in either an engaged position or a disengaged position by inserting a Locking Fastener 111H through the First Arm Hole and the Surface Hole 111G or through the Second Arm Hole 111E and the Surface Hole 111G, respectively.

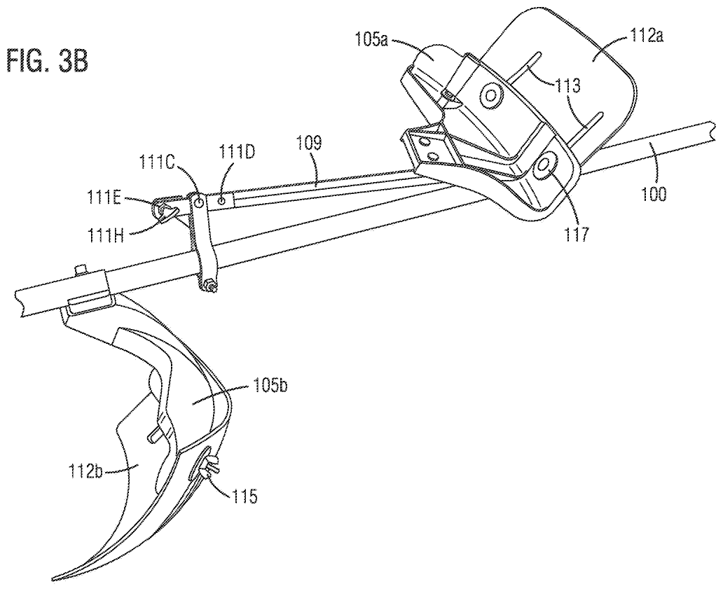

FIG. 3A depicts a view of the Trimmer 100 with the Trimmer Height Adjustment Mechanism 103 locked in the disengaged position. As shown in FIG. 3A, the Forward Guard 105A is located away from the Trimmer Head 101. The Locking Pivot Assembly 111 is shown with the Locking Fastener 111H in the locked position in the Second Arm Hole 111E. The Arm 109 is thus directed toward an end of the Trimmer 100 distal from the Trimmer Head 101. As can be seen in FIG. 3A, a Fastener Base 117 is shown on an underside of the Forward Guard 105A. The Fastener Base 117 is the terminus of a Fastener 115 (not shown) which is detachably affixed to the Forward Guard 105A and a Forward Spacer 112A. In the embodiment of the invention shown in FIG. 3A, the Aft Spacer 112B is shown as being permanently attached to the Trimmer 100. When an operator uses the Trimmer 100, the operator is able to adjust the relative height of groundcover which the operator wishes to clear. This is done by vertically adjusting the Forward Spacer 112A and the Aft Spacer 112B to the desired height. However, the operator may need to periodically clear groundcover around obstacles such as trees, rocks, etc. In such instances, it may be impractical to use a Trimmer 100 with the Forward Spacer 112A in an engaged position. Accordingly, the operator can rotate the Arm 109 and the Forward Guard 105A approximately 180° from the engaged position to the disengaged position. The operator can then lock the Arm 109 in the disengaged position with the Locking Fastener 111H. In this manner, the Trimmer 100 will have a partially-exposed Trimmer Head 101 as shown in FIG. 3A. The operator may then use the Trimmer 100 in its ordinary fashion, clearing groundcover around such obstacle. After the groundcover around the obstacle has been cleared, the operator can unlock the Locking Fastener 111H, rotate the Arm 109 from the disengaged position to the engaged position, and re-lock the Locking Fastener 111H to secure the Arm 109 and the Forward Guard 105A in the engaged position.

FIG. 3B shows an enlarged perspective view of the Trimmer 100 as shown in FIG. 3A above.

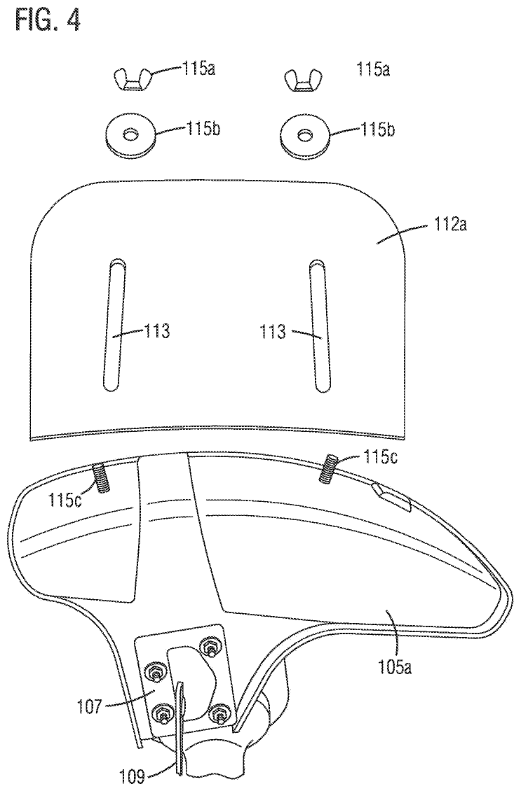

FIG. 4 depicts an exploded view of the Forward Guard 105A assembly. As shown in FIG. 4, the Arm 109 is mounted on a Bracket 107 which, in turn, is mounted on a Forward Guard 105A. A Fastener 115 is used to detachably affix a Forward Spacer 112A to the Forward Guard 105A. In the embodiments of the invention shown in FIG. 4, the Fastener 115 comprises at least one Wingnut 115A, at least one Washer 115B and at least one Bolt 115C. The at least one Bolt 115C is threaded through at least one Slot 113 in the Forward Spacer 112A. The Wingnut 115A and the Washer 115B are then threaded onto the at least one Bolt 115C in order to temporarily attach the Forward Spacer 112A to the Forward Guard 105A. While the present invention encompasses at least one such Fastener 115, the invention as shown in FIG. 4 includes two such Fasteners 115.

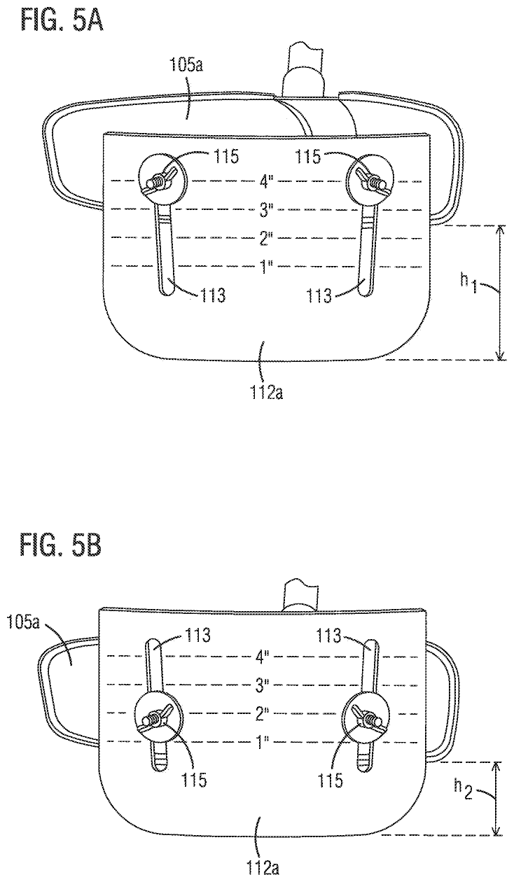

FIG. 5A depicts a front perspective view of the Trimmer Head Adjustment Mechanism 103. As can be seen in FIG. 5A, the Forward Spacer 112A is detachably affixed to the Forward Guard 105A by at least 1 Fastener 115. The Fastener 115 is threaded through at least one Slot 113. As shown in FIG. 5A, this results in a relative height h₁, i.e., the distance between a bottom edge of the Forward Guard 105A and a bottom edge of the Forward Spacer 112A.

FIG. 5B depicts a front perspective view of the Trimmer Height Adjustment Mechanism 103. As shown in FIG. 5B, the Forward Guard 105A is detachably affixed to a Forward Spacer 112A by at least one Fastener 115. At least one Slot 113 is formed in the Forward Spacer 112A and the Fastener 115 is threaded there-through. Importantly, Fastener 115 must have an outer diameter greater than the width of the Slot 113. As shown in the embodiment of the invention in FIG. 5B, the Fastener 115 comprises a Wingnut 115A and a Washer 115B, with the Washer 105B having a greater outer diameter than the width of the Slot 113. This allows a compression fit between each spacer and the corresponding guard whereby the fastener can be loosened, the spacer can be adjusted upwards or downwards, and the fastener can be re-tightened. As shown in FIG. 5B, the relative height h₂ has been adjusted by moving as compared to the relative height h₁ shown in FIG. 5A. This was accomplished by: first, loosening the Fastener 115; second, repositioning the Forward Spacer 112A to a lower desired height; and thirdly, re-locking (e.g., re-tightening) the Fastener 115. Thus, the only difference between FIG. 5A and FIG. 5B is that the Forward Spacer 112A has been readjusted from a relative height of h₁ to a relative height of h₂. In FIGS. 5A and 5B, trim gradient lines are shown in inches, although other measurement systems such as metric could be used.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

I claim:

1. A trimmer height adjustment mechanism comprising:
(i) a forward guard;
(ii) a forward spacer; and
(iii) an arm;

2. The trimmer height adjustment mechanism of claim 1 further wherein:
the forward spacer is detachably connected to the forward guard and the forward guard is connected to the arm; and
the arm is pivotally attached to a trimmer mount;

3. The trimmer height adjustment mechanism of claim 2 further comprising:
(iv) an aft guard;
(v) an aft spacer;
wherein the aft spacer is slidingly connected to the aft guard and the aft guard is connected to a trimmer.

4. The trimmer height adjustment mechanism of claim 3 further wherein:
the forward guard and the aft guard each have at least one fastener;
the forward spacer and the aft spacer each have at least one slot dimensionally sized to accommodate the at least one fastener.

5. The trimmer height adjustment mechanism of claim 3 further wherein:
the arm has a locking pivot assembly.

6. A method of using a trimmer height adjustment mechanism comprising:
(i) step 1—loosening fasteners which connect forward and aft guards to forward and aft spacers, respectively;
(ii) step 2—vertically adjusting the forward and aft spacers to reach a desired trimmer cutting height;
(iii) step 3—tightening the fasteners to secure the forward and aft spacers to the forward and aft guards, respectively.

7. The method of using a trimmer height adjustment mechanism of claim 6 further comprising:
(iv) step 4—moving the trimmer height adjustment mechanism from an engaged position to a disengaged position by:
(a) disengaging a locking pivot assembly connected to an arm;
(b) rotating the arm from an engaged position to a disengaged position; and
(c) re-engaging the locking pivot assembly.

8. The method of using a trimmer height adjustment mechanism of claim 6 further comprising:
(iv) step 4—moving the trimmer height adjustment mechanism from a disengaged engaged position to an disengaged position by:
(d) disengaging a locking pivot assembly connected to an arm;
(e) rotating the arm from a disengaged position to an engaged position; and
(f) re-engaging the locking pivot assembly.
